(19) United States
(12) Patent Application Publication
(10) Pub. No.: US 2009/0208907 A1
(43) Pub. Date: Aug. 20, 2009

(54) DENTAL IMPLANT

(75) Inventors: Anatoli D. Dosta, Minsk (BY); Aliaksandr S. Artyushkevich, Minsk (BY); Yury A. Rozanov, Minsk (BY)

Correspondence Address: HOUSTON ELISEEVA, 4 MILITIA DRIVE, SUITE 4, LEXINGTON, MA, 02421, US

(73) Assignee: JOINT STOCK COMPANY 'ALTIMED', Minsk (BY)

(21) Appl. No.: 12/431,836

(22) Filed: Apr. 29, 2009

Related U.S. Application Data
(63) Continuation-in-part of application No. PCT/BY2007/000004, filed on Oct. 1, 2007.

(30) Foreign Application Priority Data
Oct. 30, 2006 (BY) A20061063

(51) Int. Cl. A61C 8/00

(52) U.S. Cl. 433/174

(57) ABSTRACT

The invention relates to dentistry, in particular to a group of dental implants used for two-stage implantation into the alveolar bone. Said invention makes it possible to create the conditions for successful ingrowth of bone and soft tissues into the implant obtainable by the best ingrowth of the bone tissue into the internal porous structure and the soft tissue ingrowth into a surface porous three-dimensional structure in the area of the alveolar bone. The inventive cylindrical implant, the base of which is made of titanium, comprises a cavity for the porous structure and a channel for injecting medicinal preparations, wherein the base is embodied in the form of an external thread-shaped spiral which is fastened to three longitudinal reinforcing ribs arranged inside the spiral together with the porous structure, the pore size of which ranges from 150 to 300 mkm.

### RELATED APPLICATIONS

This application is a Continuation-in-Part of PCT application serial number PCT/BY2007/000004, filed on Oct. 1, 2007, which claims priority to Belarusian Patent Application No. BY a20061063, filed on Oct. 30, 2006, both of which are incorporated herein by reference in their entirety.

### FIELD OF THE INVENTION

The invention is related to prosthetic dentistry and, in particular, to a group of dental implants intended for a two-stage implantation into alveolus.

### BACKGROUND OF THE INVENTION

Known is an implant (WO 9721393 A1) having an osseo-contacting surface with a bio-compatible porous metal area for an in-growth of osseous tissue. However, the efficiency of said osseo-fusion is facilitated exclusively by micro-structural properties of a metal surface area since an implant structure presents a cylinder having no special macrogeometry features that would promote an in-growth of said osseous tissue into said implant. The above-described implant can be considered as a prior art example concerning an implant according to the invention. Common features for both an implant according to the invention and of its prior art example are their cylinder-like shape with a threaded surface and the presence of the areas intended for an in-growth of osseous and soft tissues.

Known is an implant (DE 19816865 A1, 1999) comprising a coating of bio-active silicate glass in the area of a gingiva contact. The gingiva epithelial cells could provide a reliable fixation of said implant into the jaws due to their in-growth into an implant coating. However, an implant structure in this case only facilitates an in-growth of the tissues but it would neither promote said in-growth nor would it prevent a probable invasion of infection into an implantation area. Common features for both an implant according to the invention and of its prior art example are the use of the coating intended for an in-growth of osseous and soft tissues and a cylinder-like shape of said implant.

Known is a cylinder-shaped implant with a threaded surface (WO 9722308 A1) having the cavities for a bio-active composition which can be introduced during surgical operation. A peculiar feature of the implant in question makes in possible to administer medications into an implantation area, however, a continuous post-operating administering of medications is a problem, since the canals are not through ones.

### SUMMARY OF THE INVENTION

It is the aim of the present invention to provide a dental implant having a structure which makes it possible to achieve a reliable fixation of said implant in osseous tissue and alveolus due to a more complete fusion of said osseous tissue with a porous inner implant area and an in-growth of soft tissues into a surface porous three-dimensional polymer implant area.

The above aim is achieved by the following means.

A cylinder-shaped dental implant is comprised of a titanium-made base provided with a cavity for a porous structure and a canal for administering medications, while said base is made as an outer thread-shaped helix fixed on three longitudinal stiffening ribs with said porous structure positioned inside said helix.

A pore size of said porous structure is preferably from 150 to 300 μm

At least three stiffening ribs positioned inside said helix can be made in the form of the bridges installed between the coils of said helix.

According to another embodiment of the invention a dental implant is additionally comprised of a ring-shaped head made in the form of a surface porous three-dimensional polymer structure preferably from polytetrafluorethylene which is positioned at an outer surface of a base distal end portion in a soft tissue contact area.

According to a most preferable embodiment of the invention at the distal end portion of said base there is rigidly secured a cylinder-shaped head having an axial bore, while in a bottom portion of said head there is made a thread having a shape and a pitch similar to a shape and a pitch of an outer thread-shaped helix, and at an outer surface of an upper portion of said head there is positioned an outer ring-shaped head made in the form of a surface porous three-dimensional polymer structure, preferably from polytetrafluorethylene (PTFE).

At an upper portion of a cylinder-shaped head there is positioned a cone-shaped pin for making a tooth body, while said pin is provided with a stem having a through longitudinal channel which is fixed in an implant axial bore and is used to administer medications during operating and post-operating periods.

The above aim is also achieved in another embodiment of a cylinder-shaped dental implant with a titanium-made base comprising a cavity for a porous structure and a canal for administering medications due to said implant base made cone-shaped with an outer surface of said cone having the form of a thread-shaped helix with longitudinal through bores made between the coils of said helix, while said porous structure is positioned inside said cone.

According to the above embodiment of the present invention a porous structure could also be made with a pore size ranging from 150 to 300 μm.

Preferably a distal end portion of a dental implant in question is provided with an axial through bore for administering medications and at an outer surface of said implant distal end portion there is positioned a ring-shaped head in the form of a surface porous three-dimensional polymer structure made most preferably from polytetrafluorethylene.

The basic requirements imposed to the implantation of dental structures are bio-compatibility of the materials in use and a reliable fixation of an implant in alveolus which is achieved both by the structural features (i.e. the use of threads, grooves, recesses, complex shapes) and by the kinds of materials in use (i.e. bio-compatible titanium alloys, titanium powders) and the combinations thereof. Of no less importance is a reliable contact of soft (gingiva) tissues with an implant surface and the possibility of administering medications either during surgical activities associated with implantation or during a restoration period of healing.

An implant structure according to the invention makes it possible to achieve correspondence to the above-described requirements imposed to dental implants.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 illustrates a general view of one of the embodiments of a dental implant according to the invention and

FIG. 2 illustrates its cross-sectional view in a porous structure area.

FIG. 3 illustrates an example of another embodiment of a dental implant according to the invention.

FIG. 4 illustrates a longitudinal section of a dental implant shown in FIG. 3.

### DETAILED DESCRIPTION OF THE PREFERRED EMBODIMENTS

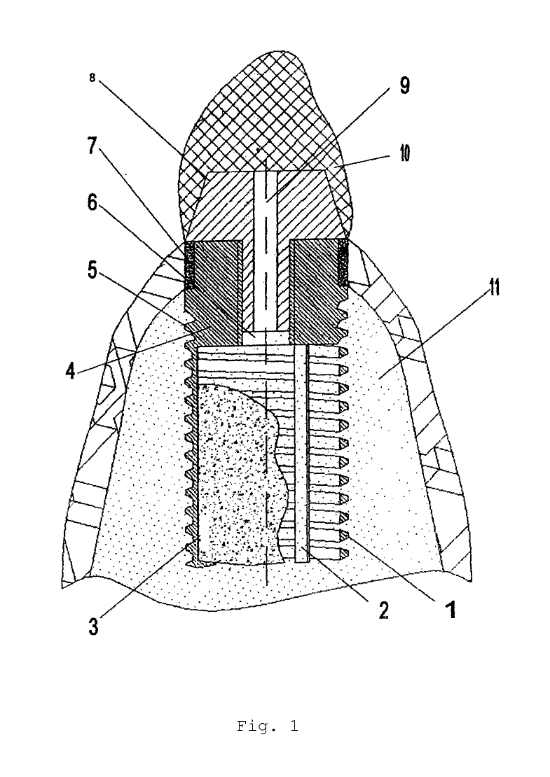

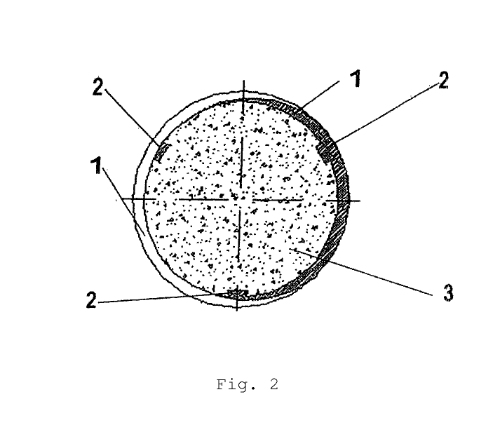

A dental implant according to the invention and implemented as it is shown in FIG. 1 and FIG. 2 and is comprised of a titanium base 1 made as a thread-shaped helix having longitudinal stiffening ribs 2 with said helix fixed thereon and a porous structure 3 positioned inside said helix. A porous structure 3 is made from titanium powder produced by crushing a titanium sponge by a method of hydrostatic compacting (See Vitjaz P. A. et al. Porous Powder Materials and Products thereof. Minsk, “Vyshejshaja Shkola”, 1987, p. 115). Making a base 1 in the form of a helix presenting a macrogeometry structure of a dental implant surface promotes an in-growth of osseous tissue through a helix inter-coil space into a microstructure of a porous insert. A range of pore sizes of a porous structure 3 from 150 to 300 μm provides an efficient recycling of a physiological fluid promoting a constant supply of the elements essential for an in-growth of osseous tissue. The choice of a pore size range is stipulated by the fact that the decrease of a pore size below the above-mentioned range results in the decrease of permeability and wettability of the pores, while an increase of a pore size over the above-mentioned range deteriorates a capillary effect which defines the impregnation of a porous space causing as a result the deterioration of an osseous tissue in-growth into an implant.

According to the example disclosed herein a cylinder-shaped head 4 is secured at the distal end portions of said longitudinal stiffening ribs 2 with a thread 5 of said head having a shape and a pitch similar to a shape and a pitch of a helix 1, while an axial bore 6 of said head is intended for administering medications during operating and post-operating periods.

At an outer surface of a cylinder-shaped head there is positioned a ring-shaped head 7 made in the form of a surface porous three-dimensional polymer structure from polytetrafluorethylene (PTFE) which presents a network of interconnected pores forming thin overlapping walls and open passages due to which said structure becomes a permeable one, thus creating the possibility of flowing through said structure of a physiological fluid. The use of polymer surface porous three-dimensional structures in dental implants is known, for example, from WO 2005107829 A2. The application of a ring-shaped head 7 makes it possible to provide a tight fitting of soft tissues to a dental implant, promoting an in-growth of said tissues and preventing an invasion of infection.

A cone-shaped pin 8 having a through longitudinal canal 9 and positioned at an upper portion of a cylinder-shaped head 4 serves for making a tooth body 10 on a bone 11.

The application of an implant is performed in the following way.

An implant base 1 having a porous structure positioned inside said base is screwed into a pre-formed bone bore 11. The base 1 is screwed until the level of alveolus coincides with an outer ring-shaped head 7 made from PTFE. Further a longitudinal canal 9 (FIG. 1) of a cone-shaped pin 8 (FIG. 1) is used to administer medications to prevent any inflammatory complications both during operating and post-operating periods.

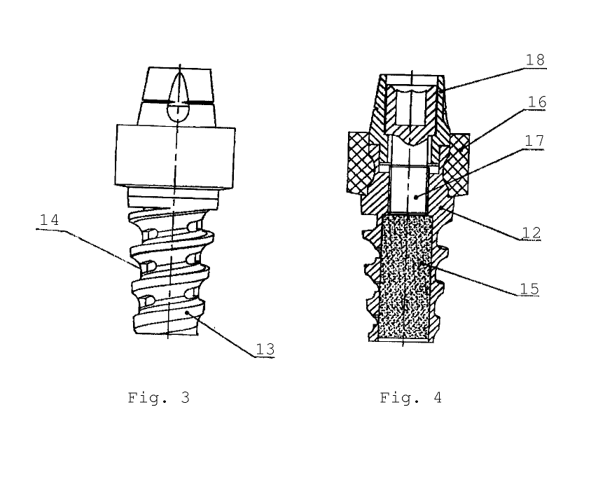

A dental implant according to the invention and implemented as it is shown in FIG. 3 and FIG. 4 is comprised of a cone-shaped base 12 with an outer surface of said cone having the form of a thread-shaped helix 13 with longitudinal through bores 14 made between the coils of said helix. A porous structure 15 is positioned inside said cone. At an outer surface of an implant distal end portion there is positioned a ring-shaped head 16 made in the form of a surface porous three-dimensional polymer structure from polytetrafluorethylene (PTFE) which projects in relation to an outer base surface positioned below. Said distal end portion of said implant is provided with an axial through bore 17 which is used for administering medications during operation and further for positioning a cone-shaped pin 18 for making a tooth body.

The above-described embodiment of a dental implant is implemented in the following way.

A cone-shaped implant base 12 with a porous structure 15 positioned inside said cone is screwed into a pre-formed bone bore. The base 12 is screwed until a projecting ring-shaped head 16 sits firmly in its place. An alveolus level at this should coincide with an outer ring-shaped head 16 from PTFE. Further an axial bore 17 is used to introduce the medicaments for preventing inflammatory complications. After a complete engraftment of a base 12 into an axial bore 17 a cone-shaped pin 18 is installed for making a tooth body.

Osseous tissue is integrated through an inter-coil space of a thread-shaped helix 1 into a porous structure 3 (See an embodiment in FIG. 1 and FIG. 2) and via the through bores 14 into a porous structure 15 (See an embodiment in FIG. 3 and FIG. 4).

A pore size in a spacious structure 3 makes up from 150 to 300 μm which provides an efficient recycling of a physiological fluid facilitating the supply of all the elements necessary for an in-growth of osseous tissue. An outer ring-shaped head 7 made of PTFE promotes an in-growth of soft tissues and prevents a probable invasion of infection into an implantation area. After an engraftment of an implant on a cone-shaped pin 8 is completed a tooth body 10 is formed.

Thus, the technical achievement of the invention filed consists in creating the conditions for a successful in-growth of osseous and soft tissues into an implant and in decreasing the probability of complications during operating and post-operating periods which on the whole results in a reliable fixation of an implant.

While this invention has been particularly shown and described with references to preferred embodiments thereof, it will be understood by those skilled in the art that various changes in form and details may be made therein without departing from the scope of the invention encompassed by the appended claims.

What is claimed is:

1. A cylinder-shaped dental implant with a titanium-made base comprising a cavity for a porous structure and a canal for administering medications, wherein said implant base is made in the form of an outer thread-shaped helix which is fixed on three longitudinal stiffening ribs positioned inside said helix and a porous structure having a pore size ranging from 150 to 300 μm is positioned inside said helix.

2. The dental implant as in claim 1, wherein the distal end portions of said longitudinal ribs are provided with a rigidly secured cylinder-shaped head having an axial bore, while in a bottom portion of said head there is made a thread having a shape and a pitch similar to a shape and a pitch of an outer thread-shaped helix, and an outer upper portion of said head is provided with an outer ring-shaped head in the form of a surface porous three-dimensional polymer structure from polytetrafluorethylene.

3. The dental implant as in claim 2, wherein at an upper portion of a cylinder-shaped head there is positioned a cone-shaped pin for making a tooth body, while said pin is provided with a stem having a longitudinal through canal which is fixed in an implant axial bore and is used to administer medications during operating and post-operating periods.

4. A cylinder-shaped dental implant with a titanium-made base comprising a cavity for a porous structure and a canal for administering medications, wherein said implant base is made in the form of an outer thread-shaped helix which is fixed on stiffening members, while a titanium-made porous structure is positioned inside said helix and an outer surface of said implant distal end portion is additionally provided with a ring-shaped head in the form of a surface porous three-dimensional polymer structure.

5. The dental implant as in claim 4, wherein a pore size of said porous structure ranges from 150 to 300 μm.

6. The dental implant as in claim 4, wherein the helix stiffening members are made in the form of three longitudinal stiffening ribs positioned inside said helix and made from the helix material.

7. The dental implant as in claim 4, wherein the helix stiffening members are made in the form of the bridges positioned between the helix coils and made from the helix material.

8. The dental implant as in claim 4, wherein a surface porous three-dimensional polymer structure is made from polytetrafluorethylene.

9. The dental implant as in claim 4, wherein a distal end portion of said implant is provided with a rigidly secured cylinder-shaped head having an axial bore, while in a bottom portion of said head there is made a thread having a shape and a pitch similar to a shape and a pitch of an outer thread-shaped helix, and a ring-shaped head in the form of a surface porous three-dimensional polymer structure is positioned in an outer surface of said bottom portion of said cylinder-shaped head.

10. The dental implant as in claim 4, wherein at an upper portion of said implant there is positioned a cone-shaped pin for making a tooth body, while said pin is provided with a stem fixed in an axial bore of said implant and having a longitudinal through channel for administering medications during operating and post-operating periods.

11. A cylinder-shaped dental implant with a titanium-made base comprising a cavity for a porous structure and a canal for administering medications, wherein at an outer surface of an implant distal end portion there is positioned a ring-shaped head in the form of a surface porous three-dimensional polymer structure.

12. The dental implant as in claim 11, wherein a base of said implant is made in the form of an outer threaded helix provided with stiffeners with a titanium-made porous structure positioned inside said helix.

13. The dental implant as in claim 12, wherein a pore size of said porous structure ranges from 150 to 300 μm.

14. The dental implant as in claim 12, wherein the helix stiffening members are made in the form of three longitudinal stiffening ribs positioned inside said helix and made from the helix material.

15. The dental implant as in claim 12, wherein the helix stiffening members are made in the form of the bridges positioned between the coils of said helix and made from the helix material.

16. The dental implant as in claim 11, wherein a surface porous three-dimensional polymer structure is made from polytetrafluorethylene.

17. The dental implant as in claim 11, wherein a distal end portion of said implant is provided with a rigidly secured cylinder-shaped head having an axial bore, while at a bottom portion of said head there is made a thread having a shape and a pitch similar to a shape and a pitch of an outer thread-shaped helix, and at an outer surface of said bottom portion of said cylinder-shaped head there is positioned a ring-shaped head in the form of a surface porous three-dimensional polymer structure.

18. The dental implant as in claim 11, wherein at an upper portion of said implant there is positioned a cone-shaped pin for making a tooth body, while said pin is provided with a stem fixed in an axial bore of said implant and having a longitudinal through channel for administering medications during operating and post-operating periods.
